(19) United States
(12) Patent Application Publication
(10) Pub. No.: US 2008/0044050 A1
(43) Pub. Date: Feb. 21, 2008

(54) Multi-Channel Speaker System

(75) Inventor: Samir Bhakta, O'Fallon, MO (US)

Correspondence Address: THOMPSON COBURN, LLP, ONE US BANK PLAZA, SUITE 3500, ST LOUIS, MO, 63101, US

(73) Assignee: GPX, INC., St. Louis, MO (US)

(21) Appl. No.: 11/464,921

(22) Filed: Aug. 16, 2006

(51) Int. Cl. H04R 1/02; H04R 9/06

(52) U.S. Cl. 381/335

(57) ABSTRACT

A speaker system is provided with a housing and a face panel extending across the housing. A speaker array comprising at least three speakers is mounted in the face panel of the housing. An amplifier is located in the housing. The amplifier has a sound processor adapted for providing at least 2.1 channels to the speaker array. A media player is operatively connected to the amplifier and the sound processor.

### BRIEF DESCRIPTION OF THE DRAWINGS

FIG. 1 shows a speaker system of the present invention comprising a housing with the speakers arranged in the housing and a CD/DVD slot style media player arranged on an end of the housing, and to illustrate the location of the CD/DVD slot style media player on the housing, FIG. 1 includes a left side view of the system;

FIG. 2 shows an alternate embodiment of the speaker system of FIG. 1 wherein the CD/DVD player comprises a retractable drawer style media player positioned at an end of the housing, and to illustrate the location of the CD/DVD media player on the housing, FIG. 2 includes a left side view of the system;

FIG. 3 shows an alternate embodiment of the speaker system of FIG. 1 wherein the media player comprises a retractable drawer style docking station adapted to operatively connect to a portable digital media player;

FIG. 4 shows an alternate embodiment of the speaker system of FIG. 3 wherein the docking station for the portable digital media player is arranged adjacent the front panel of the housing, and to illustrate the location of the system's connection points for connection to an external media device, FIG. 4 includes a right side view of the housing;

FIG. 5 shows an arrangement where the speaker system interfaces with a television set via wire connections located on the side of the housing, and to illustrate the location of the system's connection points for connection to the television set, FIG. 5 includes a right side view of the housing; and

FIG. 6 shows an alternate embodiment of the arrangement of FIG. 5 wherein the speaker system and TV are operatively connected via a wireless module of the speaker system.

### DESCRIPTION OF THE INVENTION

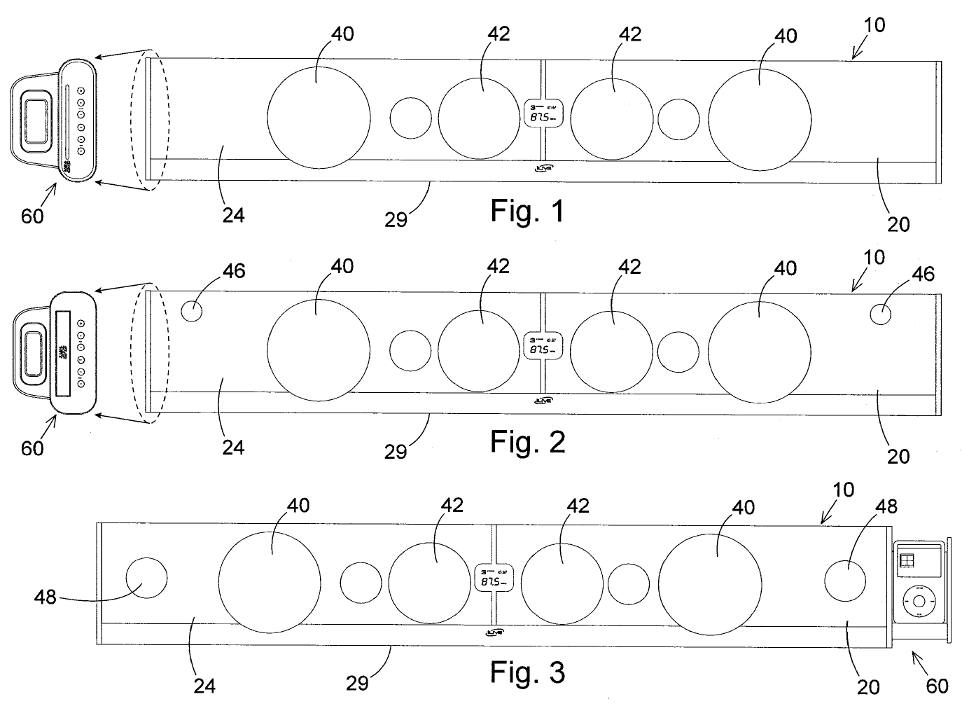

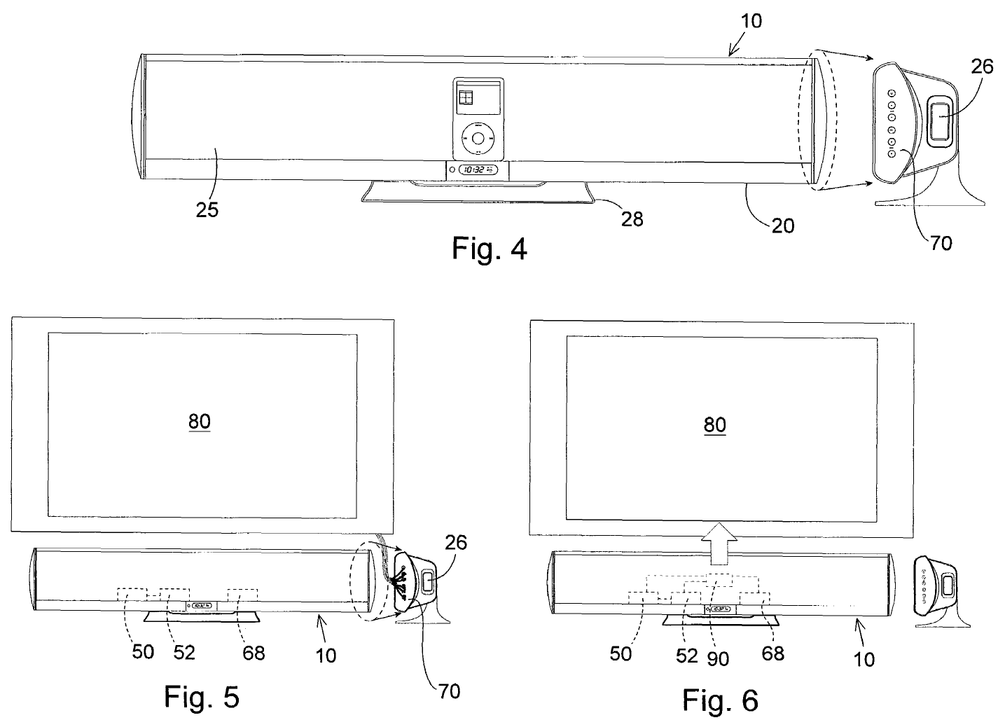

FIG. 1 shows a speaker system 10 with a housing 20 for the electronics needed for operation of the speaker system and its associated components, as will be described in greater detail below. The housing 20 has a face panel 24 that is generally flat and extends from one end (e.g. left in FIG. 1) of the housing to the other end (e.g. right in FIG. 1) of the housing to provide a foundation for mounting the speakers of the system. The face panel may be covered with a decorative plate, grating or mesh to make the speaker system aesthetically pleasing and/or to protect the speakers. FIG. 4 shows a screen with a tight hole pattern 25 designed to appear solid from a distance. The housing may have sides, a top and bottom which are contoured. The housing may be made from plastic or wood composite materials. The housing may also have air holes 26 (FIG. 4) to allow cooling and to improve acoustic performance. The housing may be positioned on a separate stand 28 (FIG. 4) or have a foundation 29 (FIGS. 1-3) integrally formed with the housing bottom. The housing may also have a top surface which is generally flat to allow other components to rest on top of the speaker system.

The speakers are generally mounted in the face panel in a line extending from one end of the housing to the opposite end of the housing. The speakers include at least two speakers 40 and at least one subwoofer 42. The subwoofer 42 is generally arranged in the center of the array with one of the at least two speakers 40 arranged at opposite ends of the housing and flanking the subwoofer. Additional speakers, including additional subwoofers, may be added to the array. In such cases, the subwoofers are generally arranged toward the center with the added speakers being arranged toward the outer ends of the array and flanking the subwoofer. A variety of speakers may be provided in the array, including tweeters 46 (FIG. 2), midranges (which may function as front, middle and rear speakers in a 7.1 channel system), and base speakers in addition to the subwoofer. A center speaker may also be provided at the center of the array. In such a case, the subwoofers may be provided on either side of the center speaker thereby flanking the center speaker. Surround sound speakers 48 (FIG. 4) may also be provided in system and at locations near the outer ends of the array. Generally, the speakers are arranged in a line but small speakers, such as tweeters, may be positioned offset from the center line. An arrangement of speakers in an offset pattern is considered to be generally within a line as defined by the rectangular box-shaped housing and within the scope of the invention. The housing may contain separate compartments for each speaker to improve acoustics. The speakers may also be mounted on angles in the face panel and aimed generally inward toward the center of the array to improve acoustics. Accordingly, the outermost speakers in the array may be angled the most.

The system includes an amplifier 50 positioned in an interior compartment of the housing. The amplifier 50 is operatively connected to a sound processor 52 that is adapted to deliver one of 2.1, 3.1, 5.1, 6.1, and 7.1 channels to the speaker array. The number of sound channels and speakers are generally matched to provide an optimum aural presentation. Additionally, the size of the speakers may be varied in accordance with amplifier and sound processor capabilities and power requirements.

The system also includes a media player 60 as an integral module of the housing. The media player may be provided at a side of the housing (FIGS. 1-3) or at the center of the housing (FIG. 4). The media player 60 may comprise a DVD player (FIGS. 1-2), CD player, or comprise a docking station or port adapted to operatively connect to a portable digital media player such as an Apple™ brand Ipod™ or MP-3 player (FIG. 3). The media player may also be adapted to handle and process multiple CDs or DVDs, and include a carousel or bin system for storing CDs or DVDs in the media player. The media player may comprise a slot system (FIG. 1) or a retractable drawer that is movable between first and second positions, wherein the first position, the drawer for the media player is extended from the housing and a second position where the drawer is inserted into the housing (FIGS. 2-4). For instance, when the media player 60 (FIG. 2) is configured as a DVD player, the drawer of the DVD player may be extended from the housing to allow insertion of a DVD into the drawer. Once the DVD is inserted in the drawer, the drawer may be inserted into the housing to allow playing of the DVD. When the media player 60 (FIG. 3) is configured as a docking station or port that is adapted to operatively connect to a portable digital media player, the drawer may be extended from the housing to allow the portable digital media player to be inserted into the docking station or port. The drawer may be provided on the side of the housing (FIGS. 2-3) or the drawer may be provided on the front of the housing (FIG. 4).

The system may also include a video processor 68 to allow processing of a DVD for display on an external media device such as a television, computer monitor, or other screen display. The video processor may be located in an interior compartment of the housing.

The system may include output and input connectors 70 (FIGS. 4-5) to allow connection of the system components, such as the amplifier, sound and/or video processor, to one or more external devices. For instance, the system's video processor 68 may have output video connections allowing the system video processor to process a DVD and permit display of the processed video on the external device. These output connectors may include RCA-type connections, an S-video type connection, or other industry standard connections. The system sound processor 52 may have output sound connections to allow sound to be processed through external speakers or other devices. The amplifier 50 may include input sound connections to allow connection to external devices, such as television sets or other generally un-portable media devices, such as stereo components, to allow their sound signals to be processed through the system. FIG. 5 shows a representative example with the system's video and sound processor output connections directed to a television set 80 and the television set's sound output directed to the system's amplifier input connections. This allows the system to supplement or replace a sound system of an external device such as a television set.

The system may also be provided with a wireless module 90, thereby allowing the various internal components of the speaker system (i.e., the amplifier 50, sound and/or video processor 52,68), to interface with external devices having wireless capability. Bluetooth™ or 2.4 GHz wireless systems may be used. As shown in FIG. 6, the speaker system is provided with a wireless module 90 to allow wireless connection with a wireless capable television set.

The speaker system may also be provided with controls for volume and sound quality, including sound equalizer controls. The speaker system may also be provided with controls to select from amongst a variety of media players, including those integral with the system and/or external media players. The speaker system may comprise multiple media players, including a DVD player and a docking station or port adapted for a portable digital media player. The speaker system may also have multiple media players arranged on different locations of the housing, including one media player on the side and one in the front, one on the side and one on the top, opposite left and right sides or any variety of combinations. The speaker system may also include a radio and/or a clock, including a clock with an alarm and/or timer capability. The speaker system may be portable and designed to operate on a temporary power supply such as batteries or a rechargeable system. The speaker system may also operate on household electrical systems.

While the present invention has been described by reference to specific embodiments, it should be understood that modifications and variations of the invention may be constructed without departing from the scope of the invention as defined by the following claims.

What is claimed is:

1. A speaker system comprising:
a housing with a generally flat face panel extending across the housing from an end of the housing to an opposite end of the housing;
a speaker array comprising at least three speakers mounted in the face panel of the housing, one of the three speakers comprising a sub-woofer;
an amplifier located in the housing, the amplifier having a sound processor adapted for providing at least 2.1 channels to the speaker array; and
a media player integrally formed in the housing and operatively connected to the amplifier and sound processor.

2. The system of claim 1 wherein the media player is adapted to process at least one of CDs and DVDs.

3. The system of claim 1 wherein the media player comprises a radio.

4. The system of claim 1 wherein the media player comprises a port adapted to operatively connect to a portable digital media player.

5. The system of claim 1 wherein the amplifier has connections adapted to operatively connect to at least one external device.

6. The system of claim 1 wherein the sound processor has connections adapted to operatively connect to at least one external device.

7. The system of claim 1 wherein the media player comprises a drawer positionable between a first position wherein the drawer is extended from the housing and a second position wherein the drawer is inserted into the housing.

8. The system of claim 7 wherein the drawer further comprises a port adapted to operatively connect to a portable digital media player.

9. The system of claim 1 wherein the media player is located in a side of the housing.

10. The system of claim 1 further comprising a wireless module adapted to interface between and operatively connect at least one of the amplifier and sound processor and at least one external device.

11. A speaker system comprising:
at least two speakers and at least one subwoofer mounted in a rectangular shaped box-like housing and arranged generally in a line from one end of the housing to the other end of the housing with the at least one subwoofer being positioned toward the center of the housing and one of the at least two speakers being positioned opposite the other at the end of the housing;
an amplifier located in the housing, the amplifier having a sound processor adapted for providing greater than 2 channels to the speakers; and
a media player integrally formed in the housing and operatively connected to the amplifier and sound processor.

12. The system of claim 11 wherein the media player comprises a DVD player with a video processor and connections to allow display of video processed on the video processor from the DVD on an external device.

13. The system of claim 12 further comprising a wireless module adapted to interface between and operatively connect at least one of the amplifier, sound processor and video processor and at least one external device.

14. The system of claim 11 wherein the media player comprises a radio.

15. The system of claim 11 wherein the media player comprises a port adapted to operatively connect to a portable digital media player.

16. The system of claim 15 wherein the port is positionable between a first position wherein the drawer is extended from the housing and a second position wherein the drawer is inserted into the interior of the housing.

17. The system of claim 11 wherein the amplifier has connections adapted to operatively connect to at least one external device.

18. The system of claim 11 wherein the sound processor has connections adapted to operatively connect to at least one external device.

19. The system of claim 11 wherein the media player is located adjacent the face panel.

20. The system of claim 11 wherein the media player is adapted to process multiple disks.
